(19) United States
(12) Patent Application Publication
(10) Pub. No.: US 2005/0015616 A1
(43) Pub. Date: Jan. 20, 2005

(54) Copy protected mastering system

(76) Inventor: Josh N. Hogan, Los Altos, CA (US)

Correspondence Address: Josh Hogan, 620 Kingswood Way, Los Altos, CA, 94022, US

(21) Appl. No.: 10/892,742

(22) Filed: Jul. 16, 2004

Related U.S. Application Data
(60) Provisional application No. 60/488,083, filed on Jul. 16, 2003.

(51) Int. Cl. H04L 9/00; G06F 12/14

(52) U.S. Cl. 713/200; 380/269; 380/200

(57) ABSTRACT

A system that inhibits unauthorized copying of digital information includes generating a sequence of symbols that has problematic recording or transmission properties and combining the generated sequence of symbols with other symbols. It further includes encoding the combined sequence of symbols into a channel bit sequence by means of a standard encoder, monitoring the digital sum variance of the channel bit sequence, rendering and transmitting a non-problematic channel bit sequence.

### CROSS REFERENCES TO RELATED APPLICATIONS

This application Ser. No. ______, docket number JH2003071, claims priority from provisional application Ser. No. 60/488,083 filed on Jul. 16th, 2003.

### RELATED APPLICATIONS

This invention relates to utility application entitled “A Digital Copy Protection System”, Ser. No. 10/879,609 filed by Josh Hogan on Jun. 29th, 2004, the contents of which are incorporated by reference as if fully set forth herein.

### FIELD OF INVENTION

The invention relates to recording and transmitting digital information and in particular to inhibiting unauthorized copying of recorded or transmitted digital information.

### BACKGROUND OF THE INVENTION

Digital information, such as, music, software or movies, is typically distributed by recording the information on low cost media, such as CD, DVD ROM (read only memory) discs, or Digital Audio Tape (DAT) or Digital VHS tape, alternatively it is distributed by transmission over digital networks, such as the Internet, or Cable or by Satellite communication systems.

There exist many consumer digital recording devices, such as computer hard discs, Ipod like devices, CD-R, CD-RW, DVD-R, DVD+RW, DVD-RW phase change recording devices, or Digital Audio Tape (DAT) or Digital VHS tape recorders. Devices such as these provide individuals with the technical capability of making low cost accurate copies of digital information distributed either by pre-recorded media or transmitted over networks.

While the ability to make an exact digital copy of digital information is valuable, for example, for archival purposes, there is also a desire by owners of digital information to limit the ability of consumers to make unauthorized copies of digital information.

This issue of the ability to make unauthorized copies applies to digital information distributed by methods that include digital transmission over digital networks and recording on consumer media. For the purpose of the following application, the word “transmitting” is intended to include sending data over digital networks and also sending data to and retrieving data from a recording device. Also for the purpose of the following application, the word “audio” is intended to include music.

Many techniques have been developed for inhibiting unauthorized copying of digital information. One approach is to encrypt the digital data which comprises the digital information, however this approach relies on a secure extensive key distribution system, which is difficult to establish in an open distribution system that does not have a secure communication channel and furthermore consumer information, such as movies, must exist in a decrypted form for use and in that state is vulnerable to release by non-compliant or hacked devices or software.

Another approach is to embed a non-volatile watermark in the digital information. The watermark contains data regarding the copyright status of the digital information. Compliant devices would honor the copyright status and would not make unauthorized copies. This approach, however, requires co-operation between the content owners, the consumer manufacturing industry and the computer industry to standardize a watermarking technology. Furthermore, there are concerns that making the watermarking robust against circumventing hacks would introduce objectionable noise into the digital information.

Yet another approach, such as employed on DVD ROM discs, is to scramble at least some of the data and store the descrambling information in a area of the disc that is outside the user data area. This approach is vulnerable to software circumventing programs, typically referred to as hacks, that are developed by sophisticated software engineers. Once developed, these hacks can be made available, typically over the Internet, as utility programs that are easy to use by typical consumers with little software expertise.

Yet another approach, described in U.S. Pat. Nos. 5,699,434 and 5,828,754 exploits the fact that when recording or transmitting digital information or data sequences, the bytes of data, referred to as symbols, are encoded into a sequence of bits, referred to as channel bits. These channel bit sequences have properties that facilitate the transmission or recording channel of the particular application. A typical encoding scheme is Run Length Limited (RLL) encoding, in which eight bit bytes, or symbols, are transformed to longer bit sequences with the constraint that there are at least a minimum number of zeros between successive ones, to ensure a minimum mark size.

The channel bit sequences also have other constraints, such as that the accumulated digital sum variance (also referred to as the accumulated digital sum value) should not exceed certain limits, so as not to disrupt accurate recovery of channel bits at reception or read back. The accumulated digital sum variance (DSV) is a measure of the DC content of the channel bits and can be measured by ascribing “+1” or “−1” values to the all the zeros between alternate sets of ones, by changing the sign at each one, and by accumulating a running total of the values. Ideally, the accumulated DSV would average out close to zero, which enables the reference of bit slicer, or decision comparator to be derived from the averaged channel bit sequence.

The copy protection approach described in U.S. Pat. Nos. 5,699,434 and 5,828,754 uses the fact that while random symbol sequences can typically be encoded into channel bit sequences with close to zero accumulated DSV, some symbol sequences exist that will typically be encoded into channel bit sequences with accumulated DSV values that exceed a predetermined value, but can also be encoded into sequences that have close to zero accumulated DSV by means of a special encoder, i.e. they require sequences that have at least two valid bit sequences, one being problematic, the other non-problematic.

While this last copy protection approach has the advantage of being implimentable by the content owners without requiring cooperation from the consumer manufacturing or computer industries. It is, however, vulnerable to Internet distributed software hacks, such as DeCSS or recompression software programs, such as Divx, because these published software programs will modify the original symbol sequences and therefore, effectively randomize the special symbol sequences that were likely to be re-encoded into channel bits with high DSV values. This approach also requires a special encoder and the existence of symbol sequences that will typically be encoded into channel bit sequences with DSV values that exceed a predetermined value, but can also be encoded into sequences that have close to zero DSV by means of the special encoder. Furthermore, errors generated by the problematic symbol sequences are likely to be corrected by the error correction techniques now being used in recording and transmission systems. These aspects place significant limitations on the applicability of the approach.

Therefore there is an unmet need for an effective copy protection system that can be implemented by content owners without requiring cooperation from large industry groups, such as the consumer manufacturing and computer industries, that is widely applicable and that is robust against Internet published circumventing software.

### SUMMARY OF THE INVENTION

The invention provides a method, apparatus and system for inhibiting copying of digital information. The invention also provides a computer readable medium containing an executable program for inhibiting copying of digital information. The invention includes generating a symbol sequence that has problematic recording or transmission properties and combining the generated sequence of symbols with other symbols. It further includes transforming at least part of the combined symbol sequence, encoding the combined symbol sequence into a channel bit sequence by means of a standard encoder, rendering and transmitting a non-problematic channel bit sequence.

### BRIEF DESCRIPTION OF THE DRAWINGS

FIG. 1 is an illustration of the copy protection system according to the invention.

FIG. 2 is an illustration of a land pit sequence with a problematic DSV.

FIG. 3 is an illustration of a variable geometry non-problematic land pit sequence.

FIG. 4 is an illustration of a variable geometry small dimension non-problematic land pit sequence.

FIG. 5 is another illustration of a variable geometry small dimension non-problematic land pit sequence.

FIG. 6 is an illustration of another embodiment of the invention.

FIG. 7 is an illustration of yet another embodiment of the invention.

FIG. 8 is an illustration of an error correction block.

FIG. 9 is an illustration of symbols and their associated DVD channel bit sequence.

FIG. 10 is an illustration of a channel bit sequence and its accumulated DSV.

FIG. 11 is an illustration of a concatenated channel bit sequence.

FIG. 12 is an illustration of bit sequence associated with problematic symbol sequences.

FIG. 13 is an illustration of a CD channel bit sequence and associated DSV data and signal.

FIG. 14 is an illustration of a CD channel bit sequence and associated DSV data and signal.

FIG. 15 is an illustration of a CD channel bit sequence with no DSV control option.

FIG. 16 is an illustration of a CD channel bit sequence and associated repetitive DSV and signal.

### DETAILED DESCRIPTION OF THE INVENTION

Data transmission and storage systems typically randomize data in a deterministic manner to enhance resilience against the inevitable errors that occur during transmission, recording or reading of data. Such random sequences typically encounter random errors that are readily corrected by standard error correction techniques. Data sequences, or symbol sequences, can be contrived so that under some circumstances they will yield non-random aligned data sequences that are error prone. Such non-random aligned data sequences are vulnerable to being uncorrectable and therefore nonfunctional, when even a small number of errors are encountered. These symbol sequences are referred to herein as problematic symbol sequences and contrived symbol sequences.

Problematic symbol sequences can be designed such that their relationship with specific characteristics of the processing systems and modulation code encoders of specific storage or transmission standards causes sub-optimal possessing which makes them error prone. These problematic symbol sequences can also be designed such that generated errors are non-random and aligned such that normal error correction techniques have sub-optimal processing which makes the errors likely to be un-correctable. (Note: for purposes of this application “transmission” is intended to include sending data over digital networks and also sending data to and retrieving data from a recording device.)

An example sub-optimal processing of problematic symbol sequences relates to processing systems in typical transmission systems which include error correction techniques, which for optimal performance deal with randomized data. Randomization is typically accomplished by combining original data, or symbol sequences, with the output of a pseudo random number generator, by means of an exclusive-or (XOR) operation. This is a deterministic randomization or scrambling transformation which is exactly reversed by an inverse scrambling transformation during processing of detected data after error correction.

Various problematic symbol sequences can be designed or contrived to exploit different aspects of transmission and recording systems. The problematic aspects cause errors when recording or playing back. By aligning the errors with the error correction axes, the probability of these errors being uncorrectable is increased. Other data, or symbol sequences can also be protected by being associated with the problematic symbol sequence.

Various rendering techniques can be used in original authorized encodings to render these problematic aspects non-problematic. At least some of these problematic symbol sequences are randomized in original authorized copies but generated or revealed in an unauthorized copy, making that copy error prone or unreliable and is therefore a mechanism for copy protecting the problematic symbol sequences. Other problematic symbol sequences are non-problematic on original authorized copies because such copies do not contain the interfering structures or have special additional processing to render them non problematic.

For example, in a first rendering technique, the problematic symbol sequence is rendered non-problematic by applying at least one transformation to the problematic symbol sequence which effectively randomizes the symbol sequence. The non-problematic symbol sequence is then transformed to a channel bit sequence, (which may be a channel symbol sequence). The channel bit sequence is transmitted or recorded. Transformations are selected, such that if copy protecting transformations are removed, or if known or possible circumventing transformations are applied to symbol sequences derived from the transmitted channel bit sequence, then a problematic symbol sequence and therefore a problematic channel bit sequence is generated (or revealed). If the problematic channel bit sequence is then transmitted or recorded, it is likely to contain errors when it is subsequently decoded, and thus is protected against unauthorized copying.

In a second rendering technique, the problematic symbol sequence is problematic in that it encodes into a channel bit sequence that has frequency components that would interfere with timing and address information embossed on recordable discs. These symbol sequences are non-problematic on original authorized stamped discs because such original stamped discs do not contain embossed timing and address information.

In a third rendering technique, the problematic symbol sequence is problematic in that it encodes into a channel bit sequence that has problematic DSV characteristics, but is rendered non-problematic by means of further encoding the channel bit sequence into a variable geometry channel pit sequence that does not have problematic DSV characteristics. This technique would typically be used in a ROM mastering system with additional control over the geometry of pits in a land pit sequence such that it can generate variable geometry pits.

A preferred embodiment of this invention would include multiple problematic symbol sequences that are rendered non-problematic by means of multiple techniques. Using multiple problematic symbol sequences and multiple rendering techniques allows using symbol sequences that will be error prone as a result of one or more of multiple circumventing hacks and unauthorized copying to different recordable discs.

A second symbol sequence, which can be a substantial amount of data, can also be protected by being a part of the problematic symbol sequence or by being associated with the problematic symbol sequence. The nature of the association could include but is not limited to; physical proximity; having overlapping error correction code-words; having at least part of the second symbol sequence encrypted or scrambled with a decryption or descrambling key as part of the problematic symbol sequence; having a pointer address in the problematic symbol sequence that is used by the second symbol sequence; having data in the problematic symbol sequence that is related to data contained in a watermark embedded in the second symbol sequence; having a requirement contained in the second symbol sequence to validate information contained in the problematic symbol sequence.

Validation includes, but is not limited to: performing a hash of the problematic symbol sequence, cryptographically relating data in the problematic symbol sequence with data in the second symbol sequence, generating a cyclic redundancy code check of the problematic symbol sequence. The validation process can be concealed by conventional steganographic techniques.

These techniques of association and validation provide the ability to copy protect a substantial amount of data with a relatively small amount of contrived problematic symbol sequences. For purposes of this invention, decryption related data includes these various methods of associating, cryptographically relating and validating symbol sequences.

A first rendering technique for making problematic symbol sequences be non-problematic on an original disc, exploits the fact that deterministic transformations randomize the problematic symbol sequence in authorized copies, but one or more of the problematic symbol sequences are revealed by copy protection circumventing techniques. These transformations may include, but are not limited to: video audio or data compression and de-compression transformations; encryption and decryption transformations; scrambling or de-scrambling transformations; other data modifying transformations; transformations such as the Content Scrambling System (CSS) implemented on some DVD movie discs and typically deployed on all DVD movie players, either hardware or software based.

The CSS scheme is a copy protection scheme that has been designed to prevent unauthorized copies of movies being played on DVD players. However, software circumventing utility programs or hacks, which are effectively an inverse CSS transformation, are readily available over the Internet. These hacks effectively re-produce the symbol sequence prior to the CSS transformation and these hacks will here be referred to as DeCSS programs.

An original authorized encoding would included the CSS transformation which has the effect of randomizing problematic symbol sequences, such that when it is encoded by the standard modulation code encoder, it produces a channel bit sequence, that does not have the problematic aspects that it would have without the CSS transformation. This allows this channel bit sequence to be distributed on DVD ROM discs and played on standard DVD players with no unacceptable problems.

If however, a DeCSS program generates an unauthorized copy of the original combined symbol sequence by reversing the CSS transformation operation, it will also undo the randomization of the problematic symbol sequence. Now, if in the process of recording this unauthorized symbol sequence on, for example, a DVD R disc, the problematic symbol sequence is encoded by a standard modulation code encoder, the resulting channel bit sequence will be a problematic channel bit sequence. Such an unauthorized copy, with a problematic channel bit sequence, will have undesirable artifacts on play back, which make the disc unusable or unattractive to view. Furthermore, if characteristics of the channel bit sequence are used as at least part of decryption, tamper resistance or copy protection related data, this information will be lost when a transformation is removed or added and therefore this can be used as another element in the copy protection system.

Unlike prior art, with this invention problematic symbol sequences do not need to have alternative unlikely but non-problematic channel bit sequences, nor is a special non-standard encoder required. Various combinations of problematic symbol sequences can be used to ensure that one or more problematic symbol sequences are revealed when the original channel bit sequence is transformed in an unauthorized manner and re-transmitted or re-recorded. Transforming in an unauthorized manner can include decompressing with one standard de-compressor and re-compressing with a different standard compressor.

A second technique for rendering problematic symbol sequences non-problematic in the original encoding does so by default. It exploits the fact that the information on stamped discs consists of a spiral land pit sequence and does not have additional embossed timing and address information. Recordable discs typically have embossed information to assist with recording. For example, a DVD+RW recordable disc includes an embossed spiral groove. The walls of the groove are modulated with a specific spatial period. This modulation (or wobble) is used to generate an electronic clock signal to accomplish accurate recording. This modulation also contains abrupt phase inversions to carry address information.

Problematic symbol sequences can be generated, such that, when encoded by a standard encoder, a channel bit sequence is generated that has a digital sum variation (DSV) with frequency content that will interfere with the embossed modulation. Other recordable discs including, but not limited to, CD-R, CD-RW, DVD+R, DVD-R, DVD-RW, DVD-RAM, AOD, Blu-Ray also have embossed timing and address information with similar opportunities for problematic symbol sequences.

A third rendering technique defines and generates pits with variable dimensions or variable geometry and uses this as a mechanism for generating a non-problematic channel bit sequence. All the described rendering techniques are mechanisms for effectively generating a non-problematic channel bit sequence. For purposes of this invention, rendering the channel bit sequence into a non-problematic channel bit sequence, includes but is not limited to the three rendering techniques described above.

The third rendering technique exploits the fact that consumer digital recording and distribution technologies are constantly being refined to provide higher capacities and faster transfer rates. This is typically accomplished by designing systems that can read and write physical marks, or pits or material property changes with smaller dimensions. For example CD and DVD ROM (read only memory) discs carry recorded information as a continuous spiral land pit sequence. In the case of CDs the minimum pit length is 830 nm and the track pitch is 1600 nm, while on a DVD disc the minimum pit length is 400 nm and the track pitch is 740 nm. This along with other efficiency improvements allows the capacity of the disc to be increased from less than 1 GByte on a CD to more than 4 GBytes on a DVD.

For purposes of this application a land pit sequence shall include sequences consisting of depressed regions, typically referred to as pits within a flat or land area and sequences consisting of raised regions, sometimes called bumps, within a flat land area. Also a pit shall refer to any type of information carrying property recorded by a mastering system.

In the case of recordable discs, such as, CD-RW and DVD+RW, the information is recorded by a physical property change of the recording material or medium, typically a phase change (affecting optical properties of the material), where information is encoded as a sequence of regions of one phase of the material separated by a region of another phase. These sequences are also referred to as space mark sequences. Once again DVD+RW has a similarly higher capacity than CD-RW due mainly to the ability to write marks with smaller dimensions than DVD. For purposes of this application a mark shall refer to any type of information carrying property recorded by a consumer recording system. Also for purposes of this application a channel bit sequence shall refer to a land mark sequence recorded by a consumer recording system, or to a land pit sequence generated by a ROM mastering system. High volume distribution typically involves distribution of ROM discs, however, low volume distribution or electronic distribution can involve writing to recordable discs. These authorized recordable discs are authorized copies and may contain some of the copy protection measures described herein.

CD or DVD ROM discs are typically manufactured in high volumes by a stamping method that uses a master disc to embosses the land pit sequence onto a plastic (polycarbonate) substrate. The master disc is typically fabricated using a short wavelength laser beam recorder or more recently using electron beam recorders, to define the land pit sequence and an etching process to generate it.

There is constant improvement in the accuracy with which these mastering technologies can be implemented, allowing pits with smaller dimensions and more accurately defined geometries to be generated. This evolution of technology allows later generation ROM discs to be fabricated with variable pit geometries. This provides an opportunity to address recording constraints in a different manner than in first generation discs and can be the basis for a copy protection mechanism. Controlling the power level or tracking of one or more recording beams are examples of means to define pits with variable geometry.

In particular, as described before, the accumulated DSV constraint is addressed by flexibility or choices in the modulation code encoding system, however, in typical encoding schemes, symbol sequences exist that allow no opportunity for encoding choice and have problematic DSV characteristics when being recorded or read back.

The ability to record smaller dimensions or variable geometries provides an opportunity to address the accumulated DSV constraint by generating pit sequences with smaller dimensions or variable geometries or a combination thereof. For example, a special long pit could be generated with a narrower width at the center region of the pit, or instead of recording a long pit, a sequence of small pits could be recorded separated by a land region that is smaller than the optical resolution of standard consumer read back devices.

The read back signals generated by these special long pits has lower amplitude than an equivalent standard long pit. It therefore contributes less to the DSV than an equivalent standard long pit. The geometry of these special long pits can be specifically designed and selected to act as a DSV control mechanism. Furthermore these special long marks can be designed to correctly generate other read back signals, such as front and back pit edge signals and tracking signals.

Consumer recorders, such as CD-R, CD-RW, DVD-R, DVD-RW, DVD+RW, etc., however, are designed to record a sequence of spaces and marks, with the marks having characteristics that are well defined by an industry standard. Such consumer recorders do not have the capability of generating equivalent special long marks. Therefore, if the consumer recorder encounters a problematic symbol sequence with no modulation code encoding flexibility or choice, then the consumer recorder will record space mark sequences with problematic DSV characteristics.

Such a consumer recorded disc, with space mark sequences with problematic DSV characteristics, will contain disruptive characteristics that cause problems on read back (or play back) of the disc. Generating the special long pits in land pit sequences that otherwise would have problematic DSV characteristics constitutes a copy protection mechanism against unauthorized copying stamped ROM discs to consumer recordable discs. Problematic DSV or accumulated DSV includes, but is not limited to: having problematic frequency components that interfere with tracking and focusing servo signals, or with clock or data recovery signals; having a large accumulated DSV that interferes with data recovery.

Another high volume approach to unauthorized copying of stamped ROM discs involves stripping a ROM disc to the substrate and using this to generate a master from which multiple unauthorized copied ROM discs can be fabricated, typically by low cost disc stampers. These low cost stampers typically will not have the resolution to transfer the special long marks. Therefore this technique also represents a copy protection mechanism against unauthorized copying of stamped ROM discs by using a stripped ROM disc as a master.

Various combinations of problematic symbol sequences can be used to protect against unauthorized copying. Some problematic sequences can be rendered non-problematic by using variable geometry land pit sequences and therefore will be problematic if copied by a system that does not have the capability of generating variable geometry pits or marks.

Other problematic symbol sequences will be effectively randomized by transformations used in the original authorized version, but will be revealed by removing copy protection transformations, thus making unauthorized copies problematic. Other problematic symbol sequences will be effectively randomized by transformations used in the original authorized version, but will be revealed by decompressing and recompressing by known or anticipated transformations, again making unauthorized copies problematic. Other problematic symbol sequences that are problematic by interfering with embossed timing and address information on recordable discs will be non-problematic on original stamped discs because such stamped discs do no contain embossed timing and address information.

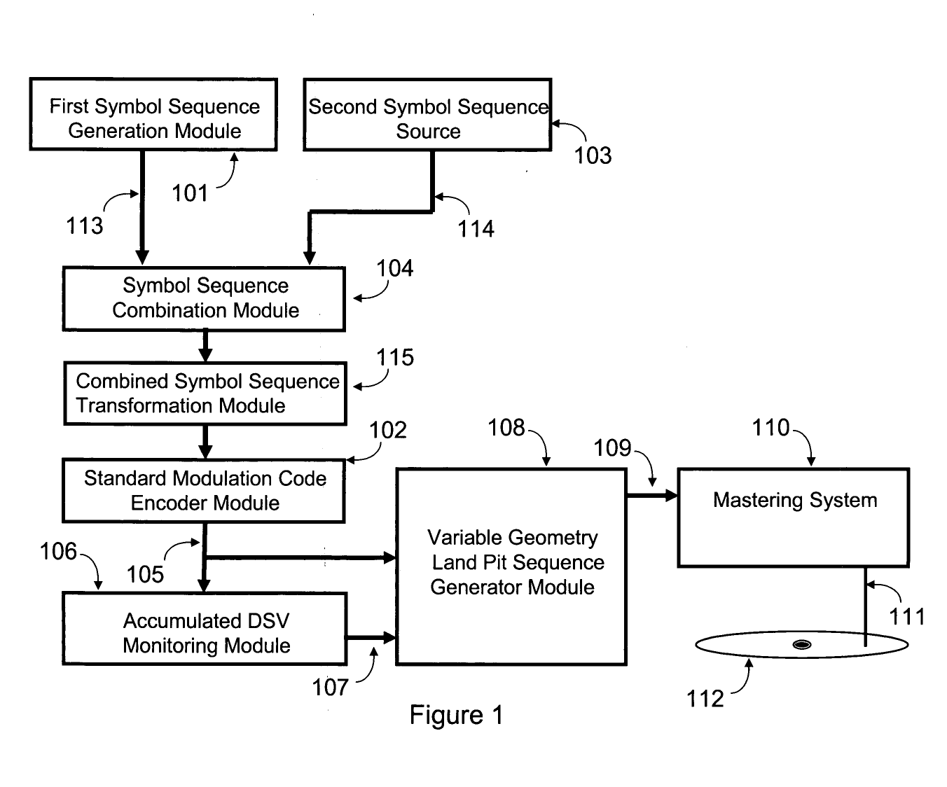

A preferred embodiment of this novel copy protection system is illustrated in and described with reference to FIG. 1, where a first symbol sequence generator module 101 generates a first symbol sequence 113 specifically designed to produce a problematic channel code bit sequence when encoded by a standard modulation code encoder module 102. This generator 101 can include inverse transformations to pre-compensate for deterministic transformations, such as scrambling or encryption transformations.

A second symbol sequence source 103; supplies a second symbol sequence 114. This second symbol sequence is a data stream that substantially constitutes the digital information that is required to be protected from unauthorized copying and is referred to as a data related sequence. This data stream includes, but is not limited to data streams, such as, a DVD or MPEG video, or an audio data stream or a software program data stream.

The problematic symbol sequence is combined with the second symbol sequence to form a combined symbol sequence. This is accomplished in a symbol sequence combination module 104, by inserting the problematic sequence in a manner that does not affect the normal operation of the second symbol sequence, other than the problematic aspects deliberately designed into the problematic symbol sequence. For example, symbol sequences that can be contrived to be problematic and are referred to as contrived symbol sequences include, but are not limited to: data inserted in the user data area of an MPEG data stream; branched scenes of a DVD sequence; substantially muted periods in audio sequences; data fields of a software program; padding data used to complete data sectors in some transmission or recording formats. Symbol sequences associated with these areas can contain arbitrary symbols and therefore can be contrived. Having decryption related data in the first symbol sequence that is required to successfully decode the second symbol sequence associates the second symbol sequence to the first symbol sequence in a manner that provides copy protection to the second symbol sequence.

Resistance to tampering with the problematic symbol sequence, by removing or modifying the problematic symbol sequence, can also be accomplished by including decryption related data within the problematic symbol sequence. This decryption data can involve the complete problematic symbol sequence by use of such standard methods as involving a hash of the problematic symbol sequence in the decryption data or involving a cyclic redundant code (CRC). Examples of use of this decryption data include requiring the decryption data to successfully unlock aspects of software programs or to unlock additional features of DVD movies.

Further tamper resistance can be achieved by having DVD format pointers adjacent to the first symbol sequence, such that modification of the first symbol sequence will lead to incorrect pointer performance. The tamper resistance association could include having information in the second symbol sequence that is related to data in the first symbol sequence and the relationship is concealed by standard steganographic techniques. The tamper resistance association strengthens the copy protection system.

At least part of the combined symbol sequence is transformed in a combined symbol sequence transformation module 115 to form a transformed combined symbol sequence. In the preferred embodiment the transformation applied includes the error correction code generator function, its associated deterministic data randomized and other deterministic data scrambler or encryption functions, such as the deterministic scrambling for CSS copy protection.

The first symbol sequence includes a problematic symbol sequence such that the transformations associated with these functions will yield a final version of the first symbol sequence, that will encode into a modulation code channel bit sequence with non-problematic DSV characteristics when encoded with the standard modulation encoder 102. If, however, circumventing transformations are removed or applied, at least some of the symbol sequences will encode into a modulation code channel bit sequence with problematic DSV characteristics when encoded with a standard modulation encoder.

The first symbol sequence also includes a problematic symbol sequence such that the transformations associated with these functions will yield a final version of the first symbol sequence, that will encode into a modulation code channel bit sequence with DSV frequency characteristics that will interfere with embossed timing and address information on recordable discs when encoded with a standard modulation encoder.

The first symbol sequence also includes a problematic symbol sequence such that the transformations associated with these functions will yield a final version of the first symbol sequence, that will encode into a modulation code channel bit sequence with problematic DSV characteristics when encoded with the standard modulation encoder 102.

The combined symbol sequence is then routed to a standard modulation encoder which has the effect of encoding the transformed combined symbol sequence into a channel bit sequence. Modulation encoders are typically used in recording and mastering systems, including but not limited to, CD, DVD, Blu-ray (or Blue Ray), AOD recording and mastering systems. The encoder 102 outputs the modulation code channel bit sequence 105 of the combined symbol sequence and directs it to an accumulated DSV monitoring module 106 which is continuously monitoring the accumulated DSV (or digital sum variance) and outputing accumulated DSV information 107 to the variable geometry land pit sequence generator module 108.

This module 108 also receives the channel bit sequence 105. Based on the DSV information 107 it generates a variable geometry land pit sequence that minimizes the problematic aspects of the channel bit sequence 105. It outputs the information 109 defining this non-problematic variable geometry land pit sequence to the mastering system 110 and thereby generates a non-problematic channel bit sequence.

A typical mastering system, such as, a laser beam recorder mastering system or an electronic beam recorder mastering system can vary the power and the tracking (or steering) of the one or more beams 111 used in the mastering process. Control over the power and tracking of the beam or beams can be used to define the variable geometry pit sequence, typically on photo-resist material on a disc. This disc is then processed, typically by an etching process, thereby recording a non-problematic variable geometry land pit sequence on the disc 112. This process results in recording or transmitting the non-problematic channel bit sequence on the disc 112 which can be used as the master disc for fabricating other discs.

ROM discs fabricated using this master, with high quality, high resolution replication devices are non-problematic and are generally playable in consumer disc players (or readers). Consumer recorders, such as CD-R, CD-RW, DVD-R, DVD-RW, DVD+RW, etc., however, will not be able to reproduce variable geometry marks. Similarly, low quality, low resolution replicators using stripped ROM discs as unauthorized masters will not have the capability of generating variable geometry marks or pits and will therefore yield copied discs that are problematic on playback. Additional copy protection is provided by other problematic symbol sequences on the original disc that may be revealed by circumventing hacks and by other problematic symbol sequences that will interfere with signals from embossed timing and address information on recordable discs.

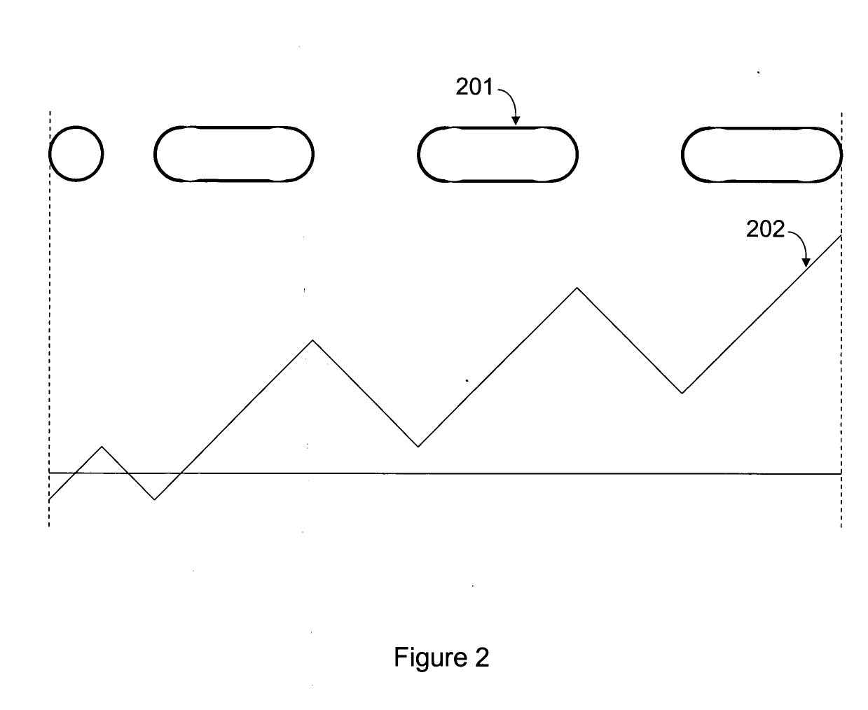

A land pit sequence with a problematic DSV is illustrated in FIG. 2. In this sequence, the pits, one of which is 201 are on average longer then the spaces between them. This means that if such a sequence is continued for prolonged period the associated DSV 202 will continue to accumulate an ever increasing magnitude (or offset) and constitute a land pit sequence with a problematic accumulated DSV. Such problematic DSV sequences can have problematic frequency components that disrupt one or more functions including tracking, focusing, clock recovery and data recovery.

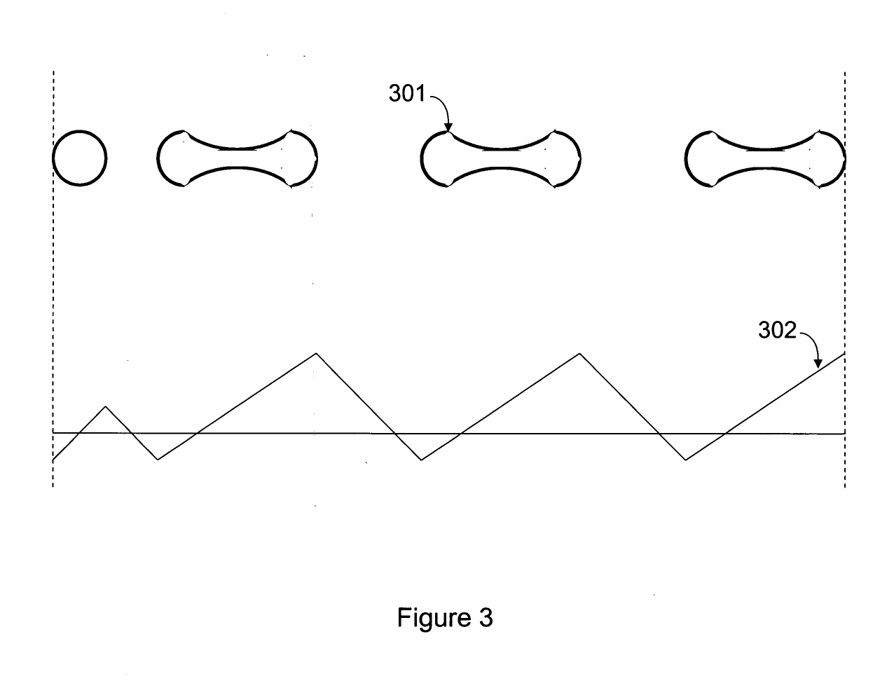

In FIG. 3 a variable geometry land pit sequence is illustrated that corresponds to that illustrated in FIG. 2, however, in FIG. 3 the long pits, such as 301 have a variable geometry in the form of a narrow waist at the center region. The exact configuration of this variable geometry (or shape) is selected to minimize the accumulated DSV, while not affecting other functions, such as tracking, etc. The resulting DSV 302 does not accumulate an ever increasing magnitude and therefore constitutes a land pit sequence with a non-problematic DSV.

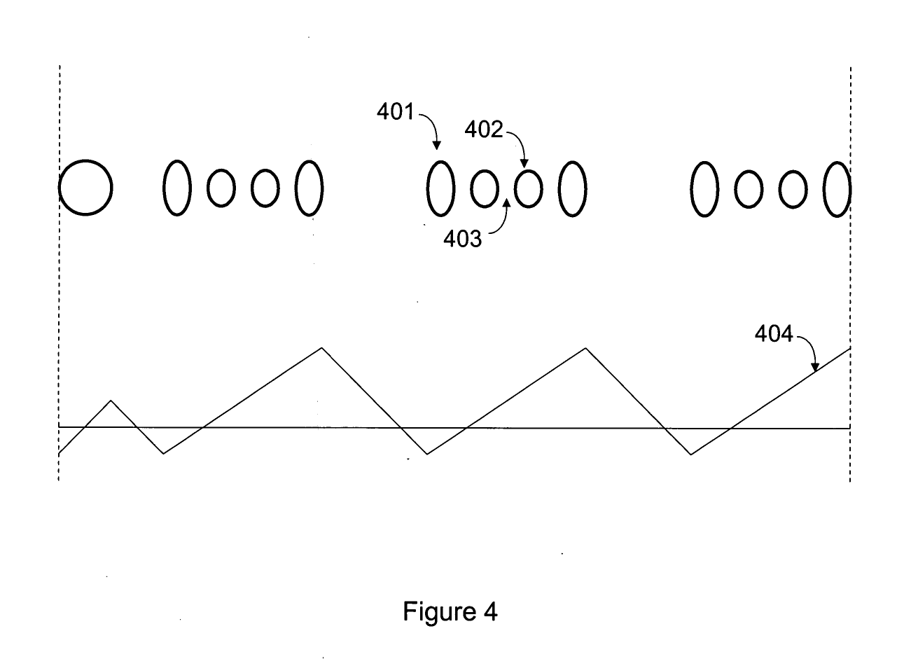

An alternative variable geometry land pit sequence is illustrated in FIG. 4, where a single long pit is replaced by a sequence of pits of smaller dimension. In this example, a long pit is replaced by four small pits, the first 401 and last of which may be wider to assist edge definition, while the internal ones, such as, 402 may be smaller. The lands between the pits, such as, 403 typically will be narrower than the optical resolution of the consumer players or readers. Such variable geometry pit sequences can also constitute a land pit sequence with a non-problematic DSV.

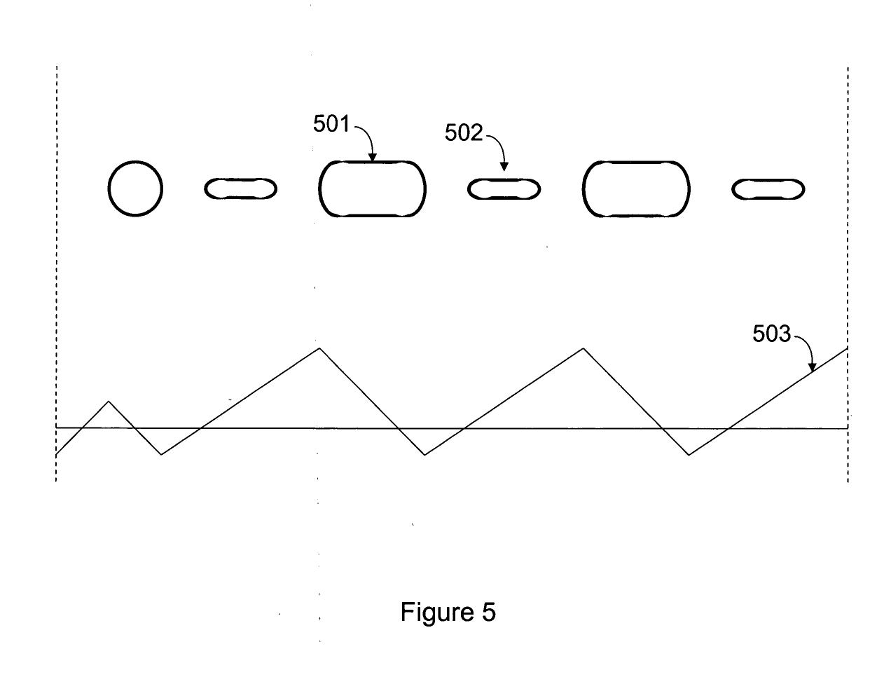

Another alternative variable geometry land pit sequence is illustrated in FIG. 5 where a long pits have normal geometry, as indicated by long pit 501. Land areas (between spaces), which normally have no structure can have small dimension pits, that are below the optical resolution of typical consumer readers, and therefore are not detected as data, but do affect the accumulated DSV. Such small pits one of which 502 is also illustrated in FIG. 5 can result in a variable geometry land pit sequence with a non-problematic accumulated DSV 503.

With this copy protection technique, the first symbol sequence can be selected to be located within user data or file system areas that are unchanged by circumventing techniques. Typical circumventing techniques are software programs, including but not limited to: known or anticipated hacks; copy protection circumventing programs such as DeCSS; de-compression and re-compression programs such as Divx. The first symbol sequence can also include symbol sequences such that the transformations associated with error correction, CSS or encryption techniques, in conjunction with transformations associated with hacking or unauthorized copying, will yield a final version of the first symbol sequence, that will encode into a modulation code channel bit sequence with problematic DSV characteristics when encoded with the standard modulation encoder. The first symbol sequence can also be repeated with 2K sector offsets, to ensure that error correcting scrambling does not randomize at least some of the problematic symbol sequences.

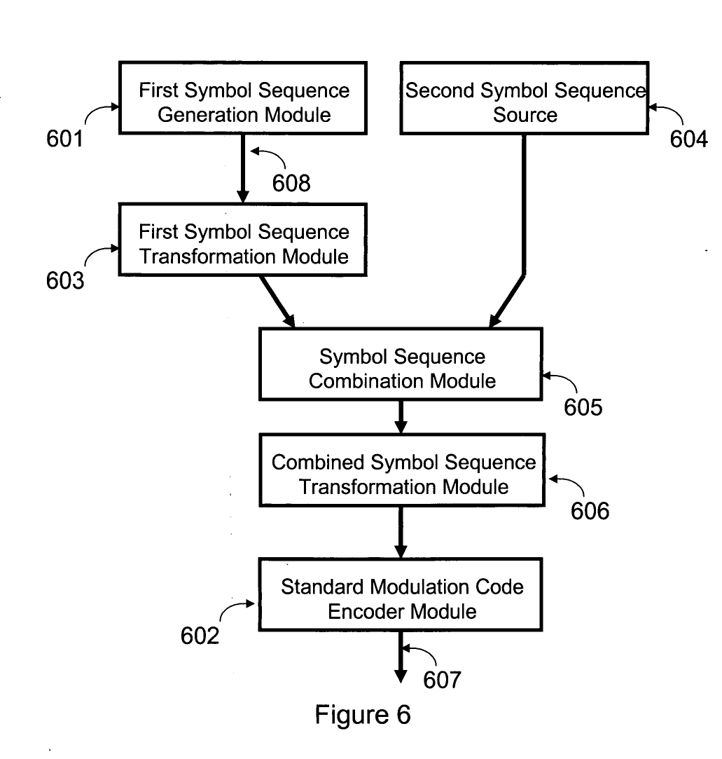

In the preferred embodiment the mastering system has the ability to generate variable geometry pits. If the ability to generate variable geometry pits is not available, a reduced set of the techniques used to render the problematic symbol sequences non-problematic can be used. For such circumstances, another embodiment of the copy protection system is illustrated in and described with reference to FIG. 6, where a first symbol sequence generator module 601 generates a first sequence of symbols 608 designed to produce a problematic channel code bit sequence when encoded by a standard modulation code encoder module 602 referred to as a standard encoder.

The problematic symbol sequence may also be further transformed by a first symbol sequence transformation module 603, which applies a first transformation to the first sequence of symbols. This first transformation may be a transformation that is the result of multiple transformations, that may include both inverse and forward transformations. These transformations may also include, but are not limited to: video audio or data compression and de-compression transformations; encryption and decryption transformations; scrambling or de-scrambling transformations; other data modifying transformations and a unitary transformation (which leaves the symbol sequence unmodified).

A second symbol sequence source 604, supplies a second symbol sequence, such as a DVD or MPEG video, or an audio data stream or a software program data stream and may substantially constitute the digital information that is required to be protected from unauthorized copying.

The problematic symbol sequence is combined with the second symbol sequence, in a symbol sequence combination module 605, by inserting the problematic sequence in a manner that does not affect the normal operation of the second symbol sequence, other than the problematic aspects deliberately designed into the problematic symbol sequence, as described in the preferred embodiment.

Resistance to tampering with the problematic symbol sequence, by removing or modifying the problematic symbol sequence, can also be accomplished by the association between the first and second symbol sequences as described in the preferred embodiment. This association includes, but is not limited to, having decryption related data within the problematic symbol sequence.

The combined symbol sequence is then transformed by a second symbol sequence transformation module 606 which transforms at least part of the combined symbol sequence to form a transformed combined symbol sequence. This second transformation may also be a transformation that is the result of multiple transformations, that may include both inverse and forward transformations.

These transformations may include, but are not limited to: video audio or data compression and de-compression transformations; encryption and decryption transformations; scrambling or de-scrambling transformations; other data modifying transformations and a unitary transformation (which leaves the symbol sequence unmodified); transformations such as the Content Scrambling System (CSS) implemented on some DVD movie discs and typically deployed on all DVD movie players, either hardware or software based.

The CSS scheme is a copy protection scheme that has been designed to prevent unauthorized copies of movies being played on DVD players. However, software circumventing utility programs or hacks, which are effectively an inverse CSS transformation, are readily available over the Internet. These hacks effectively re-produce the symbol sequence prior to the CSS transformation and these hacks will here be referred to as DeCSS programs.

This second symbol sequence transformation, in this embodiment includes the CSS transformation which has the effect of randomizing the problematic symbol sequence, or the transformed problematic symbol sequence, such that when it is encoded by the standard modulation code encoder module 602, it produces a channel bit sequence 607, that does not have the problematic aspects that it would have without the CSS aspect of the second transformation of the combined symbol sequence. This allows this channel bit sequence to be distributed on DVD ROM discs and played on standard DVD players with no unacceptable problems.

As in the preferred embodiment, if a DeCSS program generates an unauthorized copy of the original combined symbol sequence by reversing the CSS transformation operation, it will also undo the randomization of the problematic symbol sequence. Now, if in the process of recording this unauthorized symbol sequence on, for example, a DVD R disc, the problematic symbol sequence is encoded by a standard modulation code encoder, the resulting channel bit sequence will be a problematic channel bit sequence. Such an unauthorized copy, with a problematic channel bit sequence, will have undesirable artifacts on play back, which make the disc unusable or unattractive to view.

Problematic symbol sequences can be designed to exploit specific characteristics of the processing systems and modulation code encoders of specific storage or transmission standards. (Again for purposes of this application “transmission” is intended to include sending data over digital networks and also sending data to and retrieving data from a recording device.)

An example of problematic symbol sequences relates to processing systems in typical transmission systems which include error correction techniques, which for optimal performance deal with randomized data. Randomization is typically accomplished by combining original data, or symbol sequences, with the output of a pseudo random number generator, by means of an exclusive-or (XOR) operation. This is a deterministic randomization or scrambling transformation which is exactly reversed by an inverse scrambling transformation during processing of detected data after error correction.

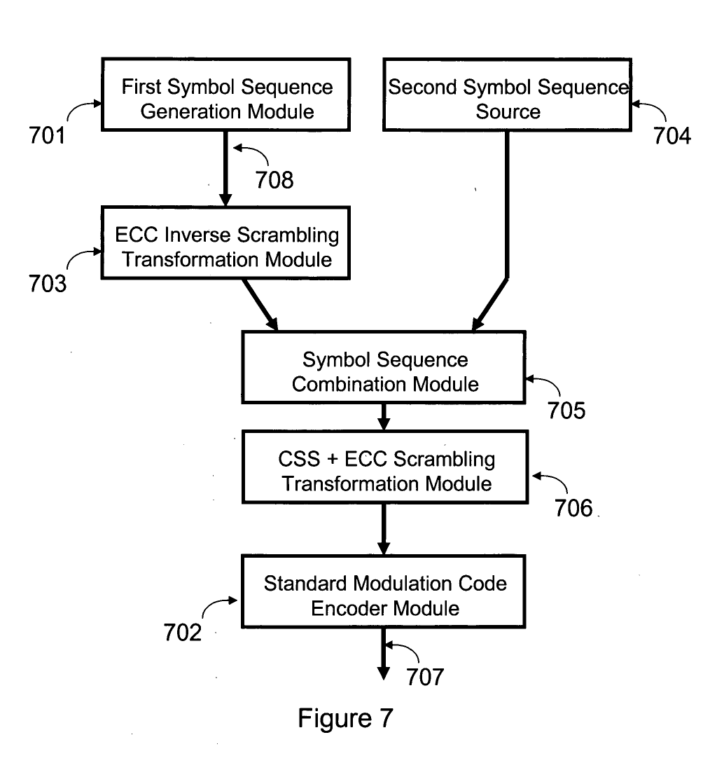

In another embodiment of this invention, illustrated in FIG. 7, the first symbol sequence 708 generated in the first symbol sequence generator module 701, is an ordered, non-random set of symbols that constitutes sub-optimal error correction codewords that are problematic for error correction. The first symbol sequence transformation module 703 is an error correction code (ECC) inverse scrambling transformation module associated with the ECC system.

The second symbol sequence source 704 provides the digital data sequence to be protected, which is combined in the symbol sequence combination module 705 with the first transformed symbol sequence. The combined symbol transformation module, in this embodiment the CSS+ECC scrambling transformation module 706, includes the CSS copy protection transformation and also the error correction scrambling transformation.

The CSS transformation effectively re-randomizes the transformed problematic symbol sequence, such that it no longer constitutes sub-optimal error correction codewords that are problematic for error correction. If however, a DeCSS program reverses the CSS transformation, then the resulting symbol sequence will contain problematic symbol sequences that are revealed without the CSS transformation and that have sub-optimal error correction characteristics.

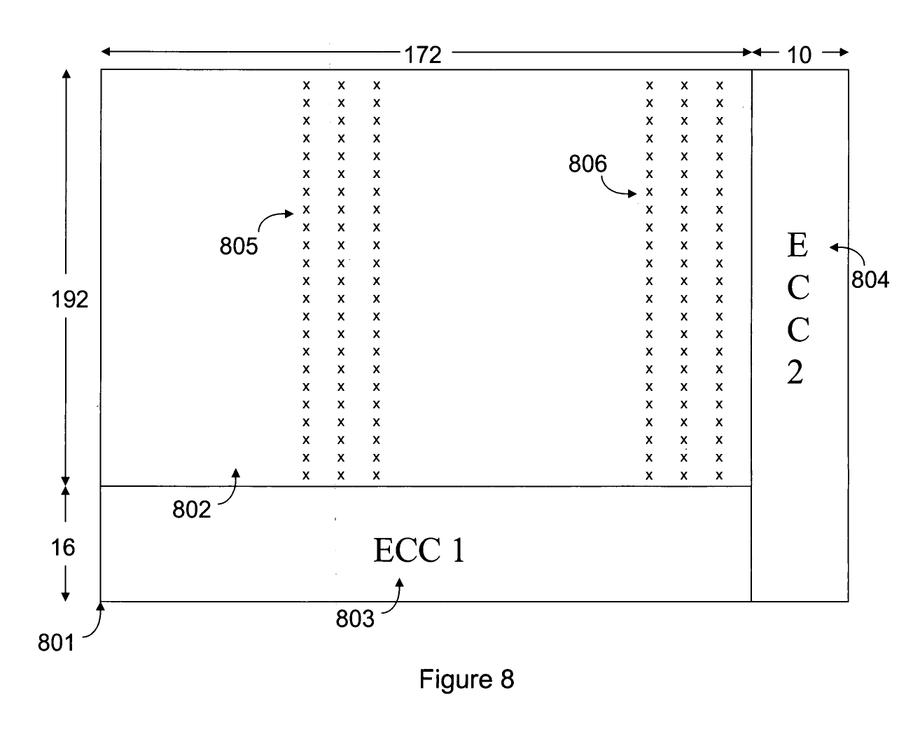

A typical two dimensional error correction block 801, such as used in the DVD format is illustrated in FIG. 8. It is a Reed Solomon cross product error correction block and consists of a 172×192 array of eight bit data bytes or symbols 802. To each column of 192 symbols 16 error correction symbols are added and form the ECC 1 block 803. To each row of 172 symbols 10 error correction symbols are added and form the ECC2 block 804.

Such cross product error correction blocks are very powerful in correcting random errors, however a relatively small number of aligned (non-random) errors can overcome the correction capability of the block. Such aligned errors are illustrated by the columns of “x”s 805, 806. If the number of aligned errors in the horizontal direction exceeds 10 and the number of aligned errors in the vertical direction exceeds 16, then the errors cannot be corrected. In practical error correction circuitry only a few (2 or 3) errors can be directly corrected. Correcting more errors requires an iterative erasure flagging process using the second level of error correction. The time involved in such iterations can cause undesirable viewing interruptions.

The problematic nature of problematic symbol sequences can be enhanced by contriving symbol sequences that are aligned along both dimensions of the error correction product code and also are designed to encode into modulation codewords that have error propagation properties to make the sequence more vulnerable to errors. The problematic symbol sequence can be further contrived to be likely to cause mis-correction by the error correction process, thus making the problematic symbol sequence more likely to be uncorrectable.

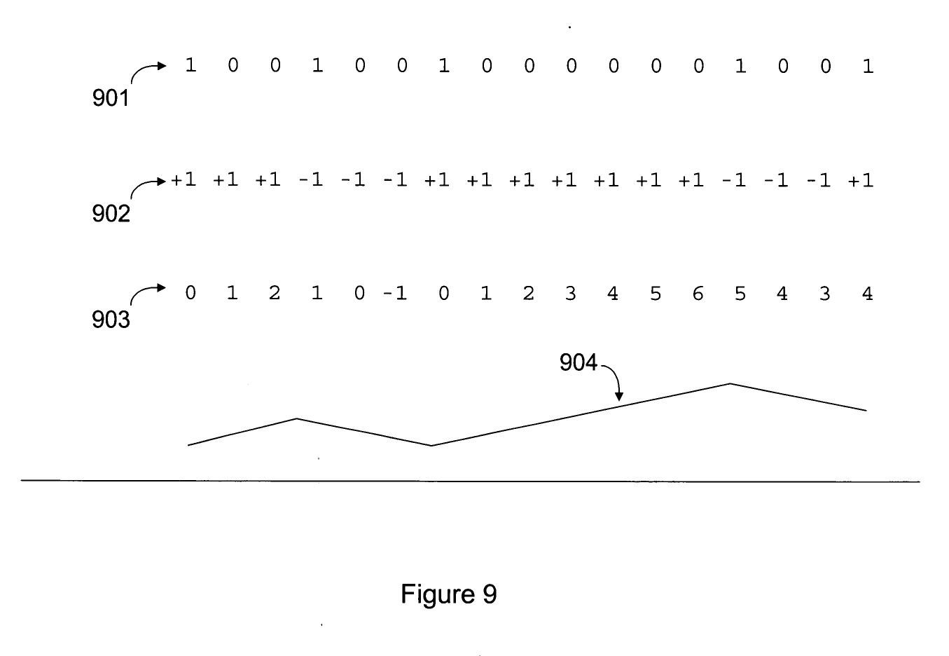

These error correction related problematic symbol sequences are referred to here as sub-optimal error correction codewords. The symbol sequences can also be designed to encode into channel bit sequences with problematic accumulated digital sum variance (DSV). A channel bit sequence and its associated accumulated DSV is illustrated in FIG. 9, where a channel bit sequence (or channel bit stream) 901 is shown along with its associated “+1” and “−1” sequence 902 and its associated accumulated DSV value 903, also illustrated graphically by 904.

As can be seen from this example in FIG. 9, which is a “1” followed by the bit sequence associated with the DVD modulation code for symbol “240”, the accumulated DSV associated with this bit sequence is not zero. Also since the presence of a “1” in the bit sequence inverts the sign of the sequence 902, (or the direction of accumulation), an odd number of “1”s in the sequence associated with a symbol will reverse the direction of accumulation, while an even number of “1”s will not reverse the direction of accumulation, i.e. an odd parity causes reversal.

In modulation encoding standards, various mechanisms are used to control the accumulated DSV so it does not have problematic frequency components that would interfere with tracking and focusing servo signals, or with clock or data recovery signals.

For example in the DVD format sync symbols are inserted every 91 symbols and these sync symbols can have either an odd or even number of “1”s as a means of controlling DSV. Also, of the 256 possible symbols, 87 have alternate bit sequences that have opposite parity. In addition, a symbol being encoded from state 1 of the encoding table may be replaced with its state four encoding if it does not conflict with other encoding rules, such as, that there must always be at least two zeros between adjacent ones. A DVD encoder uses tables with four states as part of the mechanism for ensuring the encoding rules can be followed.

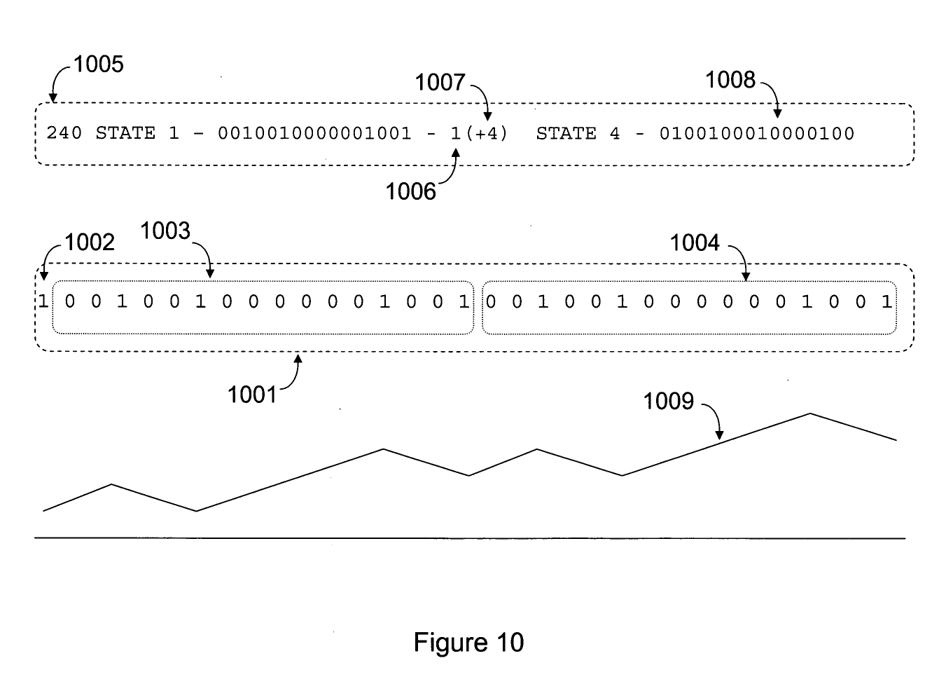

A concatenated DVD bit sequence 1001 is illustrated in FIG. 10. It consists of the last bit 1002 of a sync symbol, which is always a “1”, followed by the sixteen bit sequence 1003 representing the symbol “240” encoded from state 1 of the encoding table and a second bit sequence 1004 also representing the symbol “240” encoded from state 1 of the encoding table.

The row of characters 1005 in FIG. 10, consists of the symbol 240, encoded in state 1, to its 16 bit sequence and the state 1006 in which the next symbol must be encoded i.e. state 1. The row also consists of the accumulated DSV 1007 of the sixteen bit sequence. The row further consists of the symbol “240” 1008 encoded in state 4. The codeword in state 4 begins with “01” and cannot be used to follow the bit sequence of the first “240” symbol because there would only be one zero between the last one of the bit sequence of first “240” and the first one of the bit sequence of the second “240”, which would violate the encoding rule of always having two zeros between adjacent ones.

Thus a symbol sequence that consists of successive “240” symbols following a sync symbol, encoded by a standard DVD encoder, can only produce a unique channel bit sequence and that sequence has an inexorably increasing accumulated DSV 1009. Symbol “240” is here used for illustrative purposes. Other symbols can be selected that yield a similarly inexorably increasing or decreasing accumulated DSV. This inexorable nature can be used as the basis for ensuring the bit sequence is problematic.

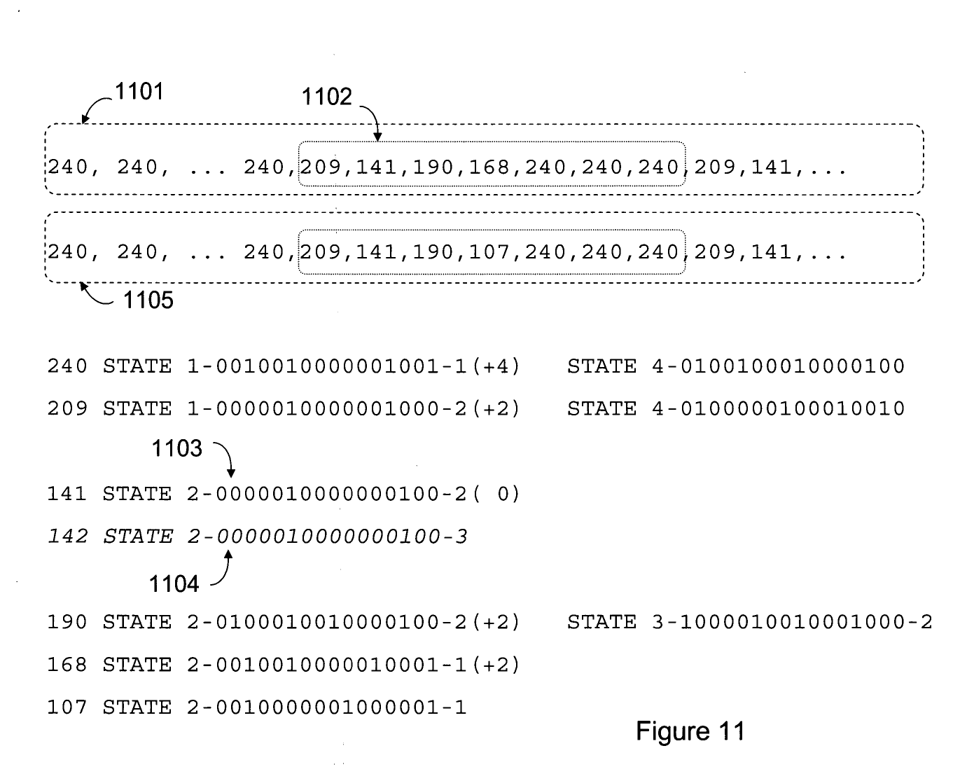

Further problematic symbol sequences, with no opportunity for an encoder to control the DSV, are illustrated in FIG. 11. The first problematic sequence 1101 includes a sequence of problematic “240” symbols followed by the sequence 1102 which contrives, by means of symbol “209” to encode the symbol “141” in state 2 and then the symbol “190”. Then follows symbol “168” which leads the encoder back to state 1, which allows the problematic “240” symbol sequences to be resumed.

It can be seen that the bit sequence for “141” 1103 and the bit sequence for “140” 1104 are identical. Correctly decoding “140” relies on correctly decoding the following symbol “190” in its correct state. Incorrectly decoding the “190” symbol can cause two symbols to be incorrectly decoded. The probability of this occurring is enhanced by the high accumulated DSV value.

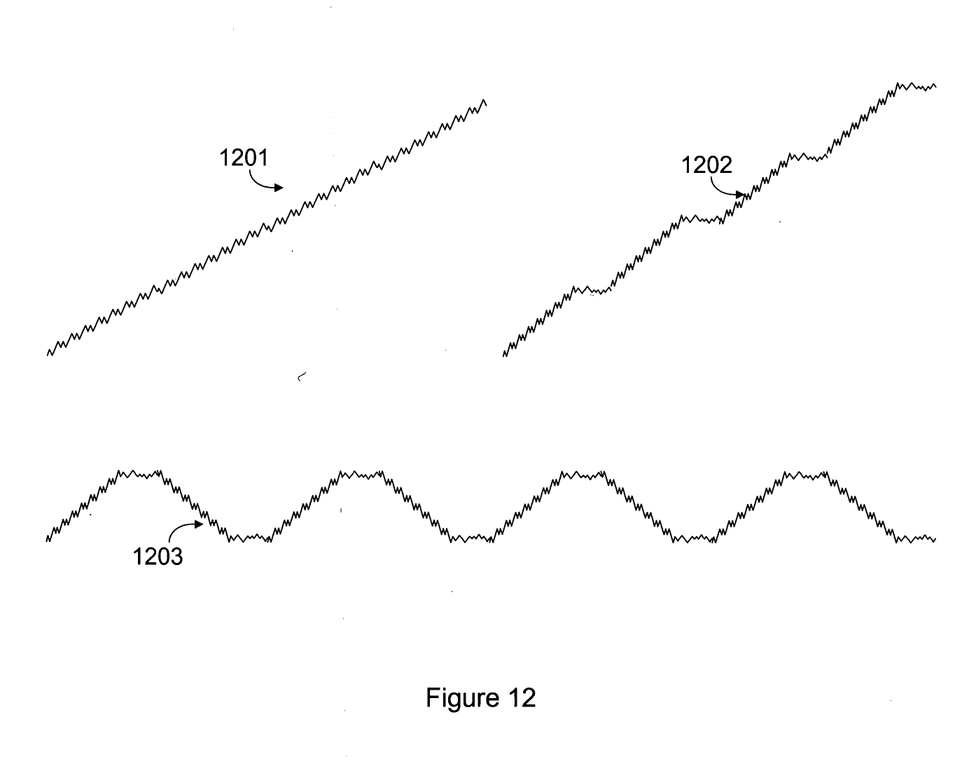

The inexorable bit sequences of some problematic symbol sequence arrangements are illustrated in FIG. 12. There the DSV signal 1201 shows the inexorably increasing “240” symbol sequence. The addition of the sequence 1102 of FIG. 11 is illustrated by 1202. If the symbol “168” is replaced by the symbol “107”, which has opposite parity to “168”, then the sequence 1105 has a DSV direction reversal at the symbol “107”. A repeated sequence, such as this, is illustrated by 1203 of FIG. 12.

Such a repetitive bit sequence as 1203 of FIG. 12 can have its repetitive period designed to interfere with servo control, clock or data signals, or with the embossed timing and address signals of recordable discs. The period can also be designed to align with the error correction block structure to produce aligned errors of the type illustrated by 805 and 806 of FIG. 8. Multiple variations and combinations of these problematic symbol sequences can be designed to make the sequence error prone when unauthorized recordings are made on various recorders. Legitimate distributed versions will not be error prone because the legitimate version will, for example, still include a transformation, such as CSS scrambling, which will randomize the problematic sequences.

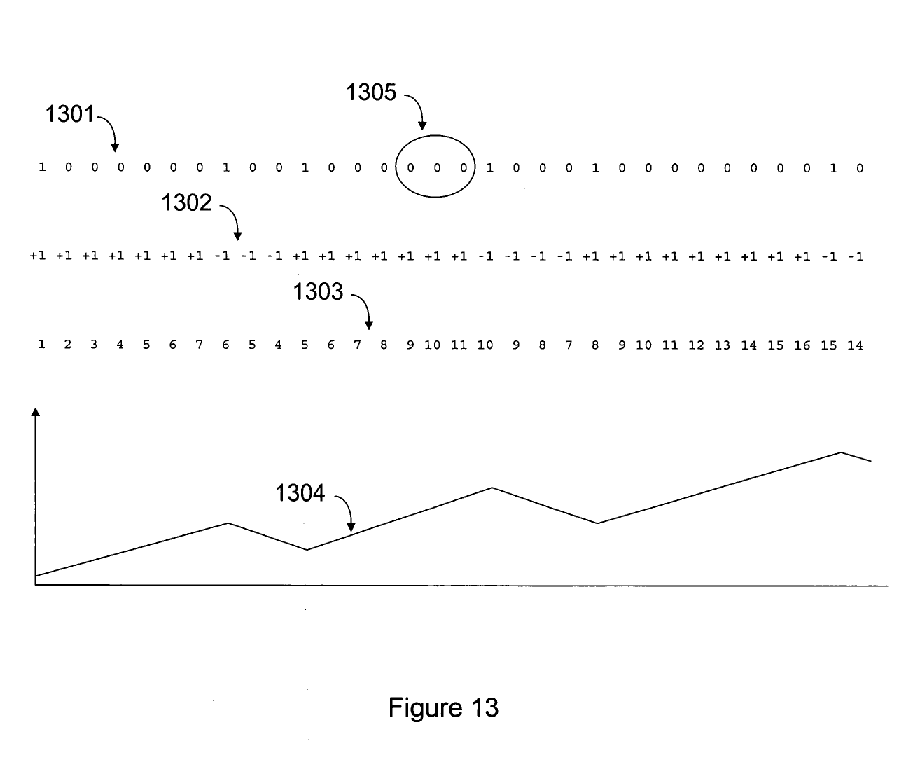

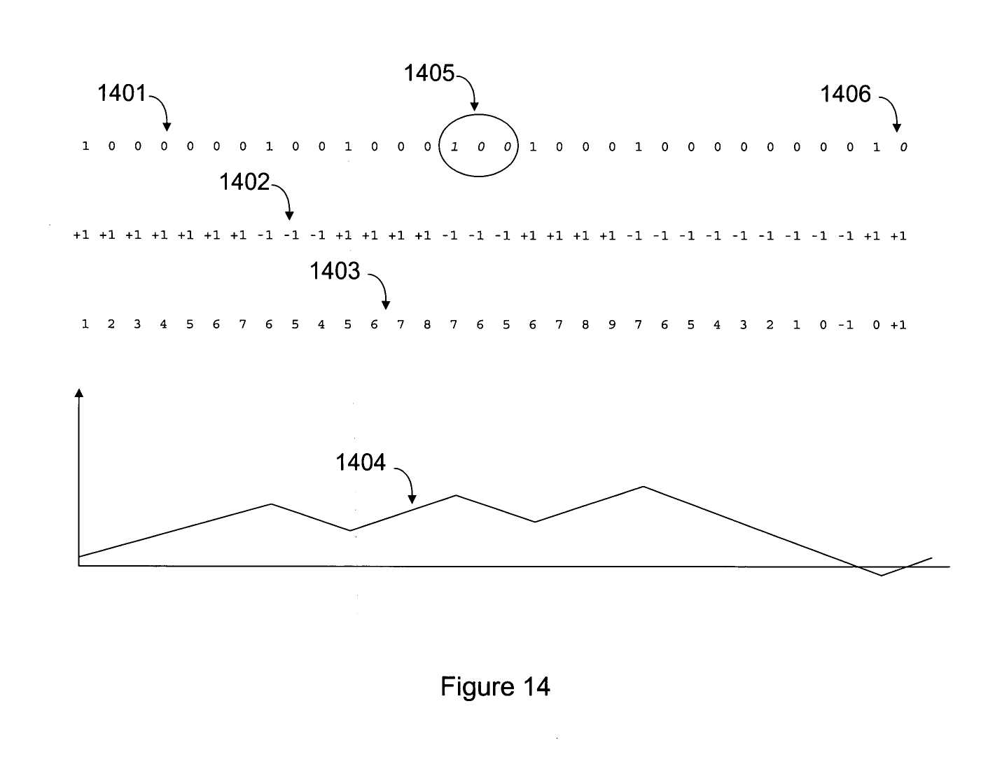

Another example of a DSV control mechanism is in the CD format, where the insertion of three merge bits between fourteen bit code words is used. These merge bits may or may not contain a “1” to control the DSV. This is illustrated in FIG. 13, where a bit sequence 1301 with its associated DSV sequences 1302, 1303 and accumulated DSV signal 1304 and the three merge bits 1305 are illustrated. Similar bit sequences and DSV signals, 1401, 1402, 1403, 1404 are illustrated in FIG. 14, where alternative three merge bits 1405 is used. (1406 is the first of the next merge bits). Using the alternative merge bits 1405 reverses the direction of the accumulated DSV, as shown by comparing 1304 and 1404 with 1404 being the preferred reduced accumulated DSV choice.

However the optional aspect of inserting or not inserting a “1” in the merge bits only exists if the resulting bit sequence conforms to the standard encoding rules, which in the CD standard requires no fewer than two and no more than ten zeros between any adjacent pair of ones.

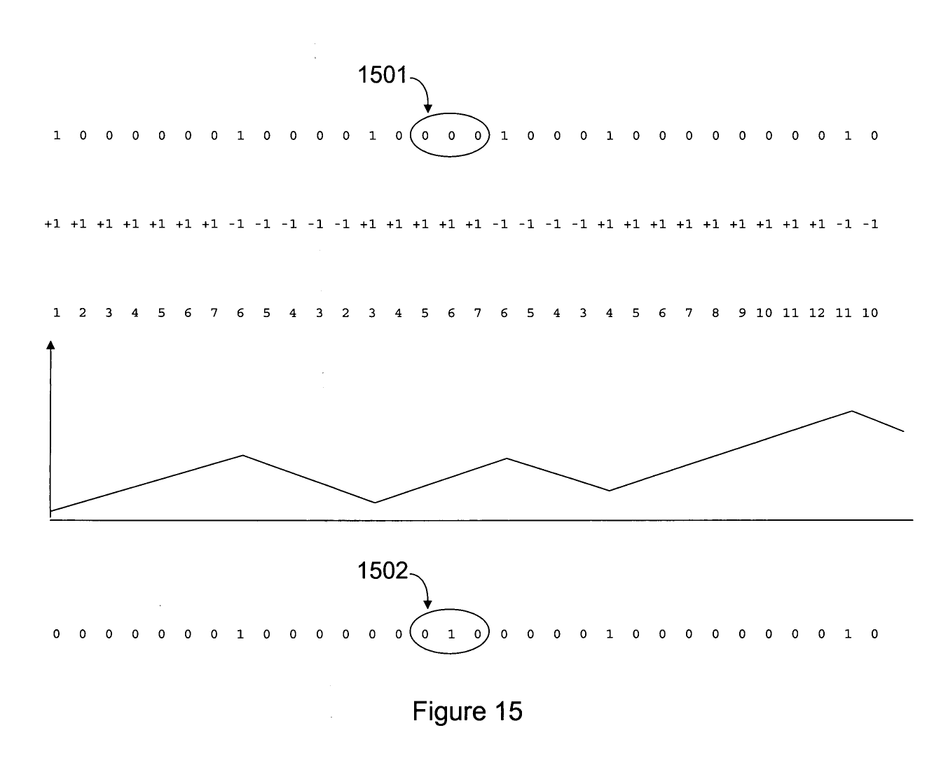

This is illustrated in FIG. 15, where two examples of bit sequences are shown. In one case 1501 the merge bits must be all zeros. In the other case 1502, the merge bits must contain a “1”. In both cases the merge bits do not provide the ability to arbitrarily control the accumulated DSV. Typically, when randomized data is being encoded, these situations with no DSV control occur randomly distributed through out the bit sequence and do not constitute a problem.

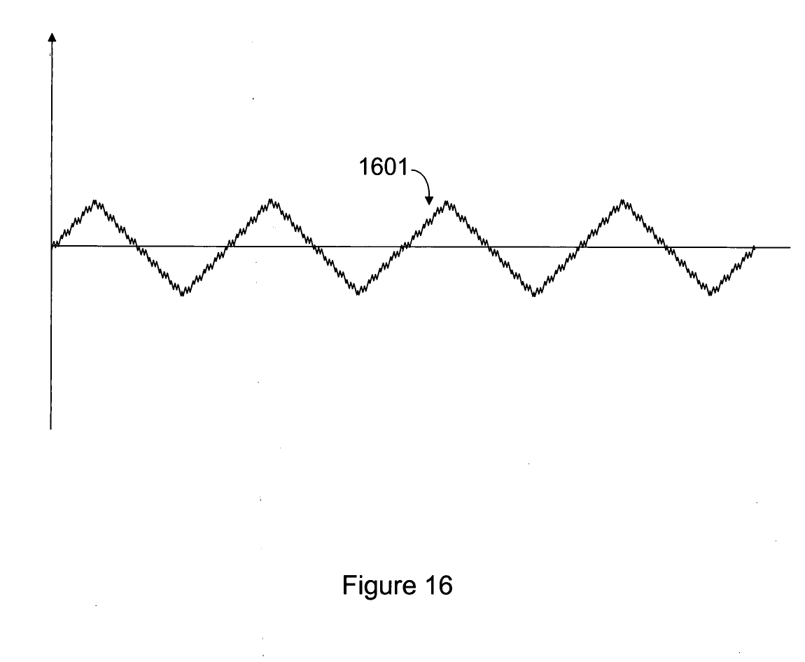

However, symbol sequences can be generated that allow the DSV to only be controlled at infrequent predetermined points. This provides a mechanism for generating symbol sequences that standard encoders will encode with predetermined frequency content, such as illustrated in FIG. 16 by the waveform 1601.

Recordable CD and DVD discs have embossed modulated grooves to assist in accurate recording. An embodiment of this invention contrives encoded channel bit sequences that will have frequency content that interferes with the embossed signals on recordable discs to cause inaccuracies during the recording and read back process, which makes the recorded disc error prone. ROM discs do not have these modulated grooves and therefore no interference occurs to cause inaccuracies which therefore allows original ROM discs to be error free.

In another example of these copy protection techniques, problematic symbol sequences could be revealed upon recompression by a published software program, such as MPEG4 based Divx. This can be done by analyzing the deterministic nature of the recompression (and if necessary prior decompression) program and generating an inverse transformation. Variations could be employed, such that at least some problematic symbol sequences would be revealed, when different recompression factors were used. All of the above described techniques can be employed in various combinations to provide protection against unauthorized recording on any of a number of recordable formats.

In addition to DVD and CD, authorized information can be published on other existing formats, such as mini-disc and future formats such as Blu-ray or AOD formats which have or will have standard encoders, Similarly transmission standards have standard encoders. Formats, such as DVD or CD, include stamped (or mass produced ROM) discs and discs that can be written to by consumer DVD or CD writers, often referred to as recordable media. The master disc from which stamped discs are duplicated is typically written to by a laser beam recorder and in that sense ROM discs are also recordable media. For purposes of this invention, recordable media includes, but is not limited, to consumer recordable optical discs and read only (ROM) stamped optical discs, magnetic discs, magnetic tape and optical tape.

Yet another example could include various combinations of the problematic channel bit sequences, such as, having repetitive problematic sequences located to induce problems on adjacent tracks. As another example, data randomization could be accomplished by encrypting the data on the disc. If the decrypted data were recorded without the encryption randomization then problematic first symbol sequences would be revealed and exist on the unauthorized version on the recordable disc, rendering it problematic. Other examples will be apparent to persons skilled in the art.

For purposes of this invention: a “transformation” includes any operation that modifies a symbol sequence and a unitary transformation leaves the symbol sequence unchanged; a “channel bit sequence” includes a channel symbol sequence, where each symbol may have multiple values corresponding to multiple bits; “transmitted” or “transmitting” includes, but is not limited to, recorded or recording.

Many variations of how transformations are applied are possible. Multiple transformations could be applied independently to sequences of symbols, or combined and then applied. Transformations could be applied independently to the first and second symbol sequences prior to them being combined, or the symbol sequences could be combined prior to transformations being applied. This could include error correction transformations where error correction codewords are generated independently for different symbol sequences and the codewords are combined by means of exclusive-or (XOR) operations.

The invention includes generating symbol sequences that are already transformed thereby avoiding the necessity of generating an original problematic symbol sequence, because this would be functionally equivalent to generating a problematic symbol sequence and then applying a transformation. Many configurations for applying transformations and combining symbol sequences or channel bit sequences are possible.

It is understood that the above description is intended to be illustrative and not restrictive. Many of the features have functional equivalents that are intended to be included in the invention as being taught. For example, many variations and combinations of the variable geometry sizes of pits are possible. Long pits with wider rather than narrow long pits could be generated. This approach is applicable to various generations of technology, including the present CD and DVD systems, emerging Blu-ray and AOD versions and future as yet undefined versions. Other standards have different ECC structures than DVD. The techniques described can be designed to match these other ECC structures. Various combinations could be used to inhibit cross standard unauthorized copying.

As another example, the disruptive DSV characteristic could be a large accumulated magnitude or offset, or could be a repetitive sine-wave like wave form problematic frequency content. The problematic frequency content could be designed to interfere with signals derived from embossed structures on recordable discs, typically used to carry timing and address information including, but not limited to: land groove structures; modulated or wobbled groove; pits; pre-pits; dibits.

Different aspects of the described embodiments can be combined either in whole or in part. All of the embodiments are amenable to any computer readable mediums, in the form of an executable program that performs the steps as outlined in the figures.

The scope of this invention should therefore not be determined with reference to the above description, but instead should be determined with reference to the appended claims, along with the full scope of equivalents to which such claims and figures are entitled.

1. A method of inhibiting copying of digital information, the method comprising:
generating a first symbol sequence that is a problematic symbol sequence;
combining the first symbol sequence with a second symbol sequence that is associated with the first symbol sequence to form a combined symbol sequence;
applying at least one transformation to at least part of the combined symbol sequence to form a transformed combined symbol sequence;
encoding the transformed combined symbol sequence into a channel bit sequence;
rendering the channel bit sequence into a non-problematic channel bit sequence; and
transmitting the non-problematic channel bit sequence.

2. The method of claim 1, wherein the first symbol sequence includes a contrived symbol sequence.

3. The method of claim 1, wherein the first symbol sequence includes decryption related data.

4. The method of claim 1, wherein the first symbol sequence is unchanged by circumventing techniques.

5. The method of claim 1, wherein the first symbol sequence is revealed by circumventing techniques.

6. The method of claim 1, wherein the problematic symbol sequence is problematic by means of forming sub-optimal error correction codewords.

7. The method of claim 1, wherein the problematic symbol sequence is problematic by means of encoding by standard encoders to a channel bit sequence with a problematic accumulated digital sum variance.

8. The method of claim 7, wherein the problematic accumulated digital sum variance is problematic by means of problematic frequency content.

9. The method of claim 1, wherein the second symbol sequence is a data related sequence.

10. The method of claim 1, wherein the second symbol sequence is associated with the first symbol sequence in a manner that provides copy protection.

11. The method of claim 1, wherein the second symbol sequence is associated with the first symbol sequence in a manner that has tamper resistance.

12. The method of claim 1, wherein the non-problematic channel bit sequence includes a variable geometry land pit sequence.

13. The method of claim 12, wherein the variable geometry land pit sequence is transmitted by means of a mastering system.

14. The method of claim 13, wherein the variable geometry land pit sequence is transmitted by means of controlling at least one mastering beam.

15. A system for inhibiting copying of digital information comprising:
generating a first symbol sequence that is a problematic symbol sequence;
combining the first symbol sequence with a second symbol sequence that is associated with the first symbol sequence to form a combined symbol sequence;
applying at least one transformation to at least part of the combined symbol sequence to form a transformed combined symbol sequence;
encoding the transformed combined symbol sequence into a channel bit sequence;
rendering the channel bit sequence into a non-problematic channel bit sequence; and
transmitting the non-problematic channel bit sequence.

16. An apparatus for inhibiting copying of digital information comprising:
means for generating a first symbol sequence that is a problematic symbol sequence;
means for combining the first symbol sequence with a second symbol sequence that is associated with the first symbol sequence to form a combined symbol sequence;
means for applying at least one transformation to at least part of the combined symbol sequence to form a transformed combined symbol sequence;
means for encoding the transformed combined symbol sequence into a channel bit sequence;
means for rendering the channel bit sequence into a non-problematic channel bit sequence; and
means for transmitting the non-problematic channel bit sequence.

17. The apparatus of claim 16, wherein the first symbol sequence includes a contrived symbol sequence.

18. The apparatus of claim 16, wherein the first symbol sequence includes decryption related data.

19. The apparatus of claim 16, wherein the first symbol sequence is unchanged by circumventing techniques.

20. The apparatus of claim 16, wherein the first symbol sequence is revealed by circumventing techniques.

21. The apparatus of claim 16, wherein the problematic symbol sequence is problematic by means of forming sub-optimal error correction codewords.

22. The apparatus of claim 16, wherein the problematic symbol sequence is problematic by means of encoding by standard encoders to a channel bit sequence with a problematic accumulated digital sum variance.

23. The apparatus of claim 22, wherein the problematic accumulated digital sum variance is problematic by means of problematic frequency content.

24. The apparatus of claim 16, wherein the second symbol sequence is a data related sequence.

25. The apparatus of claim 16, wherein the second symbol sequence is associated with the first symbol sequence in a manner that provides copy protection.

26. The apparatus of claim 16, wherein the second symbol sequence is associated with the first symbol sequence in a manner that has tamper resistance.

27. The apparatus of claim 16, wherein the non-problematic channel bit sequence includes a variable geometry land pit sequence.

28. The apparatus of claim 27, wherein the variable geometry land pit sequence is transmitted by means of a mastering system.

29. The apparatus of claim 28, wherein the variable geometry land pit sequence is transmitted by means of controlling at least one mastering beam.

30. A computer readable medium containing an executable program for inhibiting copying of digital information, where the program performs the steps of:
generating a first symbol sequence that is a problematic symbol sequence;
combining the first symbol sequence with a second symbol sequence that is associated with the first symbol sequence to form a combined symbol sequence;
applying at least one transformation to at least part of the combined symbol sequence to form a transformed combined symbol sequence;
encoding the transformed combined symbol sequence into a channel bit sequence;
rendering the channel bit sequence into a non-problematic channel bit sequence; and
transmitting the non-problematic channel bit sequence.

31. The computer readable medium as in claim 30, wherein the first symbol sequence includes a contrived symbol sequence.

32. The computer readable medium as in claim 30, wherein the first symbol sequence includes decryption related data.

33. The computer readable medium as in claim 30, wherein the first symbol sequence is unchanged by circumventing techniques.

34. The computer readable medium as in claim 30, wherein the first symbol sequence is revealed by circumventing techniques.

35. The computer readable medium as in claim 30, wherein the problematic symbol sequence is problematic by means of forming sub-optimal error correction codewords.

36. The computer readable medium as in claim 30, wherein the problematic symbol sequence is problematic by means of encoding by standard encoders to a channel bit sequence with a problematic accumulated digital sum variance.

37. The computer readable medium as in claim 36, wherein the problematic accumulated digital sum variance is problematic by means of problematic frequency content.

38. The computer readable medium as in claim 30, wherein the second symbol sequence is a data related sequence.

39. The computer readable medium as in claim 30, wherein the second symbol sequence is associated with the first symbol sequence in a manner that provides copy protection.

40. The computer readable medium as in claim 30, wherein the second symbol sequence is associated with the first symbol sequence in a manner that has tamper resistance.

41. The computer readable medium as in claim 30, wherein the non-problematic channel bit sequence includes a variable geometry land pit sequence.

42. The computer readable medium as in claim 41, wherein the variable geometry land pit sequence is transmitted by means of a mastering system.

43. The computer readable medium as in claim 42, wherein the variable geometry land pit sequence is transmitted by means of controlling at least one mastering beam.
